(19) United States
(12) Patent Application Publication
(10) Pub. No.: US 2015/0221182 A1
(43) Pub. Date: Aug. 6, 2015

(54) WAGERING GAME WITH MODIFIED CARD DECK

(71) Applicant: Aaron Paul Denenberg, Far Rockaway, NY (US)

(72) Inventor: Aaron Paul Denenberg, Far Rockaway, NY (US)

(21) Appl. No.: 14/173,673

(22) Filed: Feb. 5, 2014

(51) Int. Cl. G07F 17/32; A63F 1/00

(52) U.S. Cl. CPC G07F 17/3293; A63F 1/00; G07F 17/3244; A63F 2001/005

(57) ABSTRACT

Systems and methods for providing a wagering game with a modified card deck to include first and second unique cards in which wagering outcomes are determined based on comparison between player and dealer cards according to preset criteria and card ranking hierarchy.

### BACKGROUND OF THE INVENTION

The subject matter disclosed herein relates generally to systems and methods for facilitating game play, and in particular, wagering game play.

New wagering opportunities are always of interest to players and operators alike to make games more appealing and generate greater interest and game play. The invention is directed to satisfying these needs.

### SUMMARY OF THE INVENTION

The invention is generally directed to systems and methods for conducting wagering games using a modified deck of cards, along with a preset card ranking hierarchy.

Some embodiments of the invention are directed to a method of conducting a wagering game, comprising the steps of: receiving a first card wager and a second card wager from a participating player; providing a randomly-ordered modified deck of physical playing cards, wherein the modified deck includes fifty-two standard playing cards, a first unique card including a uniquely identifiable characteristic which differentiates the first unique card from the fifty-two standard playing cards and a second unique card including a second uniquely identifiable characteristic which differentiates the first unique card from the fifty-two standard playing cards, the first and second uniquely characteristics differentiating the first and second unique cards from one another; dealing cards from the randomly-ordered modified deck to form a player hand for the participating player and a dealer hand, wherein the player hand and the dealer hand are each dealt at least two cards; dealing one or more cards from the randomly-ordered modified deck to add to the player hand responsive to receiving a raise wager from the participating player; displaying the identity of one of the at least two cards forming the dealer hand; determining the outcome of the first card wager based on a comparison of the one of the at least two displayed dealer cards and a player selected card from the player hand according to preset criteria and ranking hierarchy of the cards in the modified deck, wherein the outcome is one of a player win, a player loss or a push; displaying the identity of another one of the at least two cards forming the dealer hand; determining the outcome of the second card wager based on a comparison of the displayed another one of the at least two dealer cards and another player selected card from the player hand according to preset criteria and ranking hierarchy of the cards in the modified deck, wherein the outcome is one of a player win, a player loss or a push; determining the outcome of the raise wager, wherein the outcome of the raise wager is a loss if any the outcomes of at least the first and second card wagers is not a player win; and settling each wager by either returning the wager, collecting the wager or awarding a payout.

In some embodiments, the player selected card is the same suit as the one of the at least two displayed dealer cards. In some embodiments, the outcome of the raise wager is a push if the outcomes of the first and second card wagers are both a player win. In other embodiments, the outcome of the raise wager is a player win if the outcomes of the first and second card wagers are both a player win.

Some embodiments of the invention are directed to a computer-aided method of providing a wagering game, including a data communication device, a processing device and a display device, comprising the steps of: receiving a first card wager and a second card wager from a participating player through the data communication device; the processing device facilitating the step of dealing cards from a randomly-ordered modified deck to form a player hand for the participating player and a dealer hand, wherein the player hand and the dealer hand are each dealt at least two cards, and wherein the modified deck includes fifty-two standard playing cards, a first unique card including a uniquely identifiable characteristic which differentiates the first unique card from the fifty-two standard playing cards and a second unique card including a second uniquely identifiable characteristic which differentiates the first unique card from the fifty-two standard playing cards, the first and second uniquely characteristics differentiating the first and second unique cards from one another; the processing device facilitating the step of dealing one or more cards from the randomly-ordered modified deck to add to the player hand responsive to receiving a raise wager from the participating player through the data communication device; displaying the identity of one of the at least two cards forming the dealer hand; the processing device facilitating the step of determining the outcome of the first card wager based on a comparison of the one of the at least two displayed dealer cards and a player selected card from the player hand according to preset criteria and ranking hierarchy of the cards in the modified deck, wherein the outcome is one of a player win, a player loss or a push; displaying the identity of another one of the at least two cards forming the dealer hand; the processing device facilitating the step of determining the outcome of the second card wager based on a comparison of the displayed another one of the at least two dealer cards and another player selected card from the player hand according to preset criteria and ranking hierarchy of the cards in the modified deck, wherein the outcome is one of a player win, a player loss or a push; the processing device facilitating the step of determining the outcome of the raise wager, wherein the outcome of the raise wager is a loss if any the outcomes of at least the first and second card wagers is not a player win; and settling each wager by either returning the wager, collecting the wager or awarding a payout through the data communication device.

In some embodiments, the communication device, processing device and display device are mounted within a unitary housing. In other embodiments, the processing device is remotely located from the display device and communication device. The computer-aided method may also include the display of a table layout including a plurality of player positions on the display device.

Some embodiments of the invention are directed to a system including a data communication device configured to receive a first card wager and a second card wager from a participating player; a processing device configured to facilitate the steps of: dealing of cards from a randomly-ordered modified deck to form a player hand for the participating player and a dealer hand, wherein the player hand and the dealer hand are each dealt at least two cards, and wherein the modified deck includes fifty-two standard playing cards, a first unique card including a uniquely identifiable characteristic which differentiates the first unique card from the fifty-two standard playing cards and a second unique card including a second uniquely identifiable characteristic which differentiates the first unique card from the fifty-two standard playing cards, the first and second uniquely characteristics differentiating the first and second unique cards from one another; dealing one or more cards from the randomly-ordered modified deck to add to the player hand responsive to receiving a raise wager from the participating player through the communication device; determining the outcome of the first card wager based on a comparison of the one of the at least two displayed dealer cards and a player selected card from the player hand according to preset criteria and ranking hierarchy of the cards in the modified deck, wherein the outcome is one of a player win, a player loss or a push; determining the outcome of the second card wager based on a comparison of the displayed another one of the at least two dealer cards and another player selected card from the player hand according to preset criteria and ranking hierarchy of the cards in the modified deck, wherein the outcome is one of a player win, a player loss or a push; determining the outcome of the raise wager, wherein the outcome of the raise wager is a loss if any the outcomes of at least the first and second card wagers is not a player win; settling each wager by either returning the wager, collecting the wager or awarding a payout through the data communication device; and a display device configured to display the identity of one of the at least two cards forming the dealer hand prior to receiving the selection of a player card and display the identity of another one of the at least two cards forming the dealer hand responsive to determining the outcome of the first card wager.

The aforementioned system may include the data communication device, processing device and display device mounted within a unitary housing. Alternatively, the processing device is remotely located from the display device and data communication device. The system may also include a plurality of player positions having display devices.

### BRIEF DESCRIPTION OF THE DRAWINGS

Other advantages of the invention will be readily appreciated as the same becomes better understood by reference to the following detailed description when considered in connection with the accompanying drawings wherein:

FIG. 1 is a process flow chart depicting an exemplary game play method configured and constructed according to some embodiments of the invention;

FIG. 2 is a process flow chart depicting another exemplary game play method configured and constructed according to some embodiments of the invention;

FIG. 3 illustrates an exemplary table layout which may be a felt table layout or implemented as a virtual layout on a display or communication device according to some embodiments of the invention; and

FIG. 4 is a schematic diagram depicting the components of an exemplary system configured and constructed according to some embodiments of the invention.

### DETAILED DESCRIPTION OF THE PREFERRED EMBODIMENT

The exemplary embodiments herein relate to various systems and methods for providing wagering games. It should be understood that each of the methods and individual steps recited herein may be partially or wholly carried out in a variety of ways and/or systems, which may include, but are not limited to, a live dealer using physical game implements, such as physical playing cards and gaming chips, an electronic gaming machine (EGM) for use by one or more players, a multiplayer platform which may include a player interface such as a touchscreen display and involve physical or virtual game symbols, a home computer and/or portable computing device, such as a tablet computer or mobile phone capable of communicating with a network or over the Internet, global telecommunication network or world wide web.

It should further be understood that the invention is directed to, among other things, methods of providing, conducting and resolving wagering games that include a sequence of controlled, non-abstract and concrete transformative events. Some of these events may involve the generation of random data and game play results for one or more players, as well as the application of such randomly-generated data to methods disclosed herein. The generation of random data may be facilitated by computerized and/or physical implements, such as a deck of playing cards and/or a random number generator. The transformative events may also include parsing of the data for comparative purposes with preset criteria to determine an outcome in a wagering game.

Selected embodiments of the invention will now be explained with reference to the drawings. It will be apparent to those skilled in the art from this disclosure that the following description of the embodiment of the invention is provided for illustration only and not for the purpose of limiting the invention as defined by the appended claims and their equivalents.

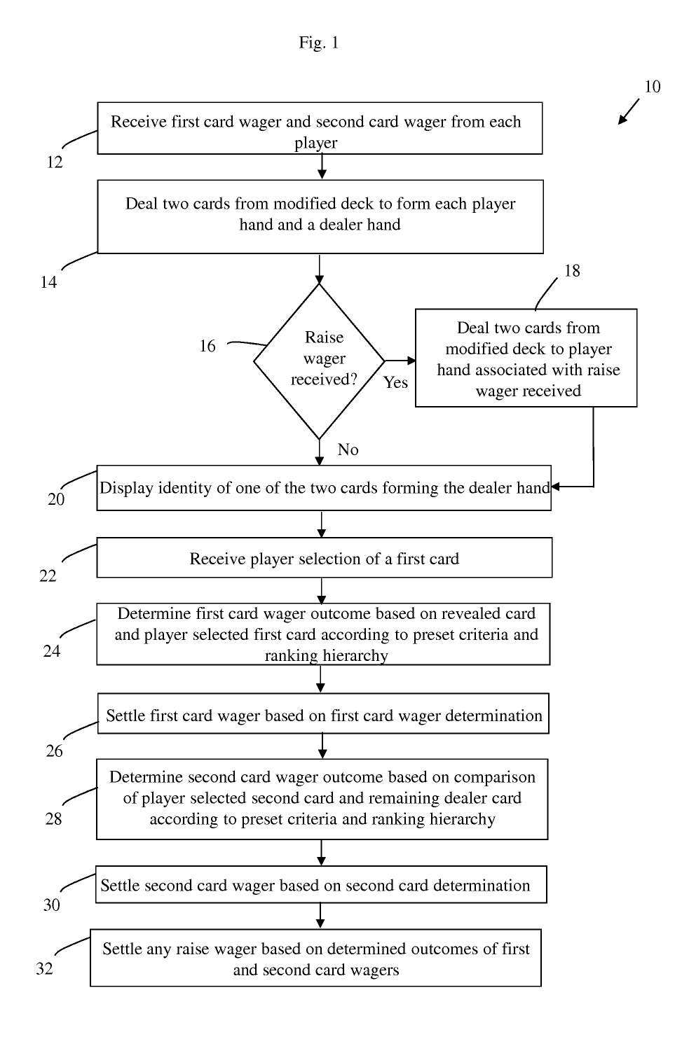

In some embodiments, the invention is directed to a game kit including one or more modified decks of playing cards, with each deck being composed of (i) a standard deck of fifty-two physical cards, (ii) a first physical card which includes at least one unique visually identifiable characteristic that differentiates the first card from the fifty-two cards in a standard deck, and (iii) a second physical card which includes at least one unique visually identifiable characteristic that differentiates the second card from the fifty-two cards in a standard deck and the first card. The game kit further includes a felt table layout having a dealer position and a plurality of player positions defined thereon. In some embodiments, the invention is directed to a method of playing a wagering game generally referred to by the reference numeral 10 in FIG. 1 which employs a single modified deck of cards from the game kit.

In step 12 one or more wagers are received from participating players. In the exemplary embodiment described herein as game method 10, at least two wagers are required to be placed, but it should be understood that one or both may be optional. One of the wagers will be received as a “first card” wager and the other wager will be received as a “second card” wager. In this embodiment, the first card and second wagers are required to be of equal amount, but in other embodiments the first card and second card wagers may be the same or different amounts.

As shown by step 14, two cards from a modified deck as described above are distributed or dealt to form a player hand of two cards each for each of the participating players and a dealer hand of two cards for the dealer. In this exemplary embodiment, all cards are dealt face down, but each player may view their own player hand. To facilitate step 14, the modified deck may be provided in a randomly-ordered condition, or alternatively, the modified deck may be provided, and then randomized to be in a randomly-ordered condition prior to engaging in a physical card dealing or distribution steps. In the exemplary embodiment described as game method 10, the first card is assigned to be a higher ranking card than the second card, that is, the first card is a “big” card and the second card is a “little” card. In some embodiments, the two cards may be the joker cards, or similar thereto, with one being the “big joker” and the other being the “little joker.” An automated shuffling device may be operatively associated with gaming method 10 for facilitating provision of the randomly-ordered modified deck of cards.

As shown by step 16, in this embodiment a raise wager may be received after cards are dealt to form player hands. If a raise wager is received from any participating player, then two additional cards will be dealt from the modified deck used to facilitate step 14 to that participating player, as shown by step 18. The raise wager may be a monetary amount equal to or different from the first card and/or second wagers.

After all raise wagers have been received in step 16 and participating players have received the two additional cards in step 18, or no raise wager is received in step 16, then game play continues and the dealer displays or otherwise reveals the identity of a first card of the two cards in the dealer hand, as shown by step 20, such as by flipping the card over from being face down to being in a face up condition.

In step 22, a selection of a first card is received from each participating player. In some embodiments, the player must select a first card which is of the same suit as the suit of the first dealer card. In other words, if the dealer's first card is a Heart, then the player must select a first card which is a Heart from the cards of the Heart suit forming the player hand. In some embodiments, the player will automatically lose the first card wager and/or second card wager if a card of the same suit in the player hand is not played. In some embodiments, a player selection of a first and the second card is received from each participating player at the same time, if the second card is not selected by default. For example, if the participating player received two additional cards in step 18, then the player may select a first and a second card from the player hand and additional cards received, that is, the group of four cards, and the remaining two unselected cards will then be discarded. Alternatively, the selection of the second card in the case of the player receiving two additional cards in step 18 may occur after resolution of the first card wager as described below.

In step 24, the outcome of the first card wager will be determined by comparing the player selected first card with the dealer first card displayed in step 20 according to a preset criteria and ranking hierarchy. In step 26 the first card wager received in step 12 of this embodiment will be settled based on the determination in step 24 as one of the following: a win, in which case a payout will be provided to the player; a loss, with the first card wager being collected; or a push, wherein the first card wager is returned to the player. It should be understood that the payout amount may be a multiple of the first card wager or even money.

In step 28, the outcome of the second card wager will be determined by comparing the player selected second card with the remaining card in the dealer hand, that is, the dealer' second card will be displayed or revealed and used to determine a second card wager outcome according to a preset criteria and ranking hierarchy. In step 30 the second card wager received in step 12 of this embodiment will be settled based on the determination in step 28 as one of the following: a win, in which case a payout will be provided to the player; a loss, with the second card wager being collected; or a push, wherein the first card wager is returned to the player. It should be understood that the payout amount may be a multiple of the second card wager or even money.

In step 32, any raise wager received in step 16 is settled based on the outcomes of the first and second wagers as determined in steps 24 and 28, respectively. In this embodiment, the raise wager is either resolved as a push or loss, in that the raise wager is a push if the first card and second card wager outcomes are both determined to be wins, and the raise wager is resolved as a loss under any other circumstances, including if one of the first card and second card wagers is resolved as a player win. In some embodiments, the raise wager is resolved as a win only if the first card and second card outcomes are both determined to be wins, that is, the participating player placing the raise wager received in step 16 wins both the first card and the second card wagers. The raise wager is resolved as a loss and collected under any other circumstances. The payout for a winning raise wager may be a multiple of the amount wagered, such as 2 to 1.

In some embodiments, the preset criteria and/or hierarchy used for determining the first card outcome in step 24 differs from the preset criteria and/or hierarchy for resolving the outcome of the second card outcome in step 28. In the exemplary embodiment discussed herein, the preset criteria and hierarchy used for determining the first card outcome in step 24 and step 28 are the same.

The preset criteria of this exemplary embodiment sets forth a comparative analysis of each of the player's first and second cards to each of dealer's first and second cards, respectively, to determine if either of the two cards being compared is included as one of various cards predefined as being in the group of trump cards. If the player's card is a trump card while the dealer's card is not a trump card, then the outcome is a player win. If the dealer's card is a trump card while the player's card is not a trump card, then the outcome is a player loss. If the player's card and the dealer's card are both trump cards then the highest ranking trump card determines the outcome.

In some embodiments, the hierarchy of trump cards, from high to low, is as follows: big card, little card, a specific card, a specific card, a group of cards of the same suit. In the embodiment described herein, the hierarchy of trump cards, from high to low, is as follows: big card, little card, the two card or deuce of a first suit, the two card or deuce of a second suit, the group of remaining cards of the second suit from Ace to the three card, wherein Ace is the highest rank and the three card is the lowest rank.

For illustrative purposes, this exemplary embodiment will be further described with the first suit being diamonds and the second suit being spades. Thus, the hierarchy of trump cards in this exemplary embodiment is as follows: high card, low card, Two of Diamonds, Two of Spades, the remaining spades with the Ace of Spades being the highest rank and the Three of Spades being the lowest rank.

The preset criteria further sets forth that if neither of the cards being compared are trump cards, but the cards are of the same suit, then the highest ranking card determines the outcome. In this exemplary embodiment the rank of non-trump cards is from highest to lowest, that is, from Ace to deuce. For example, if the player's card is Eight of Hearts and the dealer's card is Six of Hearts, then the outcome is a player win, whereas if the dealer's card is Ten of Clubs and the player's card is Two of Clubs then the outcome is a player loss.

The preset criteria sets forth that if neither of the cards being compared are trump cards are of the same suit, then the outcome is resolved as a player loss except if the player's card is an non-trump Ace, in which case the outcome is resolved as a push.

The various illustrative embodiments of the invention may be implemented in conjunction with a physical table as a live table game utilizing physical playing cards and money or chips representative of the actual dollar value of a wager. The physical playing surface, which may be included as part of the game kit, may include positions that facilitate play, such as designated hand placement areas for the player and dealer cards and designated wagering areas for facilitating receipt of the first card wager, second card wager and raise wager. Alternatively, the methods according to the present invention may be implemented in part or whole by computer hardware devices, and presented by means of computer program code which, by way of example, when executed by a processor, causes the display of the game and conditions of the hands on a display device.

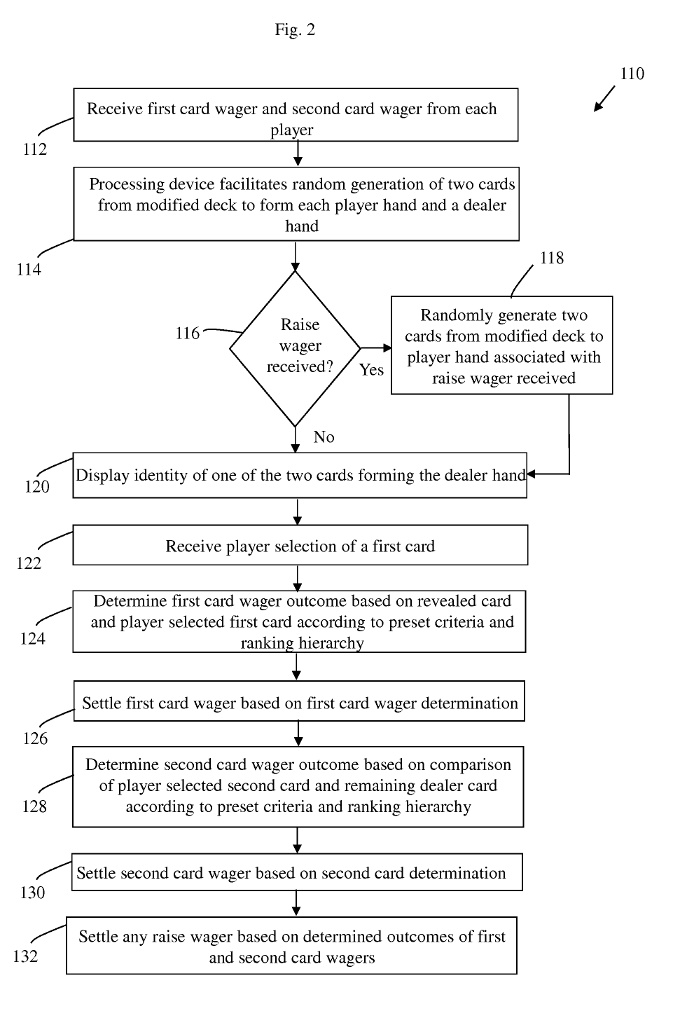

FIG. 2 illustrates an embodiment of the invention generally referred to by the numeral 110. In this embodiment, the first and second wagers may be received in step 112 as physical representations of wagers, such as gaming chips, or through selections made on a player interface provided on a data communication device. The dealing and distribution of random playing cards in the modified deck is facilitated by a processing device, as shown in step 114. The processing device may be installed in a variety of devices, such as an automated shuffler, and may be used to provide physical cards at random from the modified deck. The processing device may also be operatively associated with memory and a random number generator, and in communication with one or more display devices, such that the processing device facilitates the random selection of virtual cards from a virtual modified deck stored in the memory to be displayed on the one or more display devices. The raise wager in step 116 may be received as a physical representation of a wager or through a selection on a player interface. The processing device facilitates the provision of the two cards in step 118 upon receipt of the raise wager in step 116. The dealer card may be displayed by flipping over and/or displayed on a display device in step 120. The player selection of a first card in step 122 may be received through the player interface. The processing device employed in steps 114 and 118, or another processing device, may be utilized in the determination of first and second card wagers in steps 124 and 128. Wagers may be settled in steps 126, 130 and 132 and if won, payout may be awarded to a player account, displayed on a player interface and/or provided to the player as physical representations of monetary amounts.

In some embodiments, a method such as method 110 may be achieved by means of a display device in communication with a software program stored in a data storage device, database or memory, which is mounted on, in or adjacent the physical playing surface in association with which the game is played. In some embodiments, wagers may be received through a touchscreen display mounted on a physical gaming table. In other embodiments, players may participate in a game through a kiosk which includes a player interface displayed on a display device, and a video of the deal of cards from a modified deck may be displayed. Players may enter selections through the player interface which are then translated as actions and used to determine outcomes as if the player were physically present at a game table.

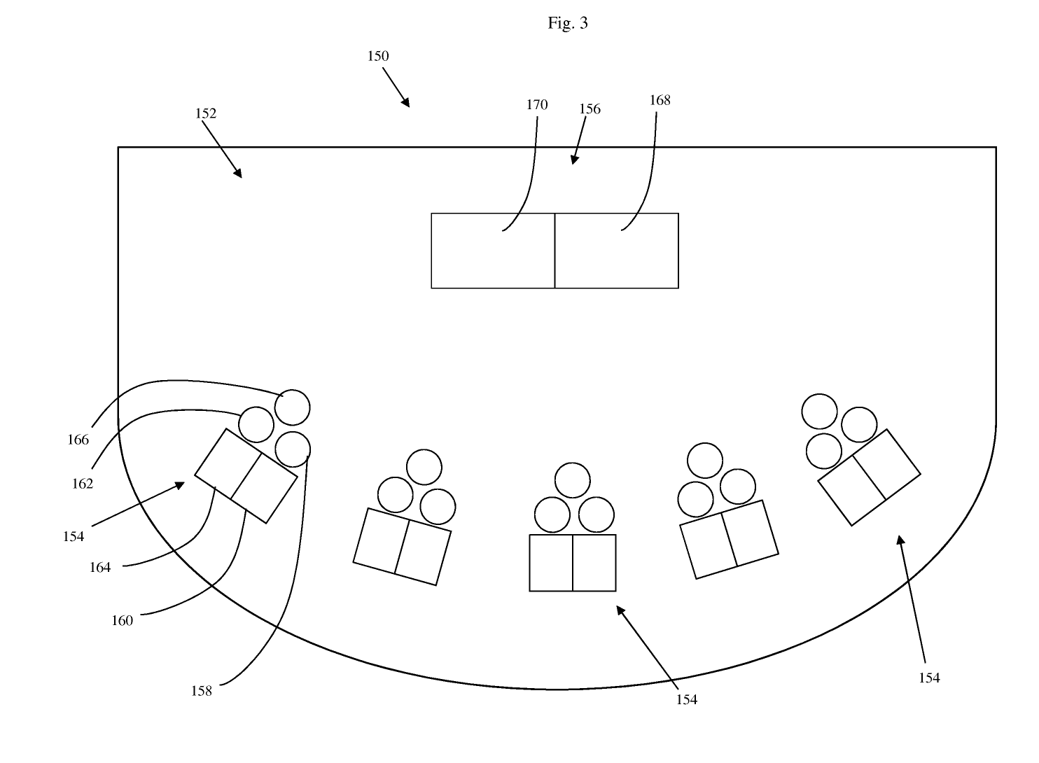

FIG. 3 illustrates an exemplary system 150 configured for operating in accordance with embodiments of the invention. System 150 includes a layout 152 for use in facilitating the presentment and display of a method of the invention such as method 10 or 110. Layout 152 may be a physical felt implemented on a gaming table and included in the kit described above, or a virtual representation of a felt table display presented on a display device, as it should be understood that the methods of the invention would function as described herein if any one or more of the layout, cards, dealers or wagering chips or apparatus were physically provided or virtually represented and facilitated through a computer with appropriate hardware devices and programs. System 150 further includes multiple player positions or interfaces 154 accessible on layout 152 and a dealer position or interface 156. It should be understood that the amount of interfaces 154 may vary and the amount shown in FIG. 3 is for illustrative purposes only. In this embodiment, each player position or interface 154 includes a first wagering position 158 for placing the first wager for receiving by the operator, a first card position 160 for displaying the selected first card, a second card wagering position 162 for placing the second card wager, a second card position 164 for displaying the selected second card and a raise wager position 166. Dealer position 156 includes a first dealer card position 168 and a second dealer card position 170. It should be understood that player interface 156 may further include a device for electronically receiving wagering credit, placing wagers and distributing payouts as described in this embodiment and in accordance with the invention.

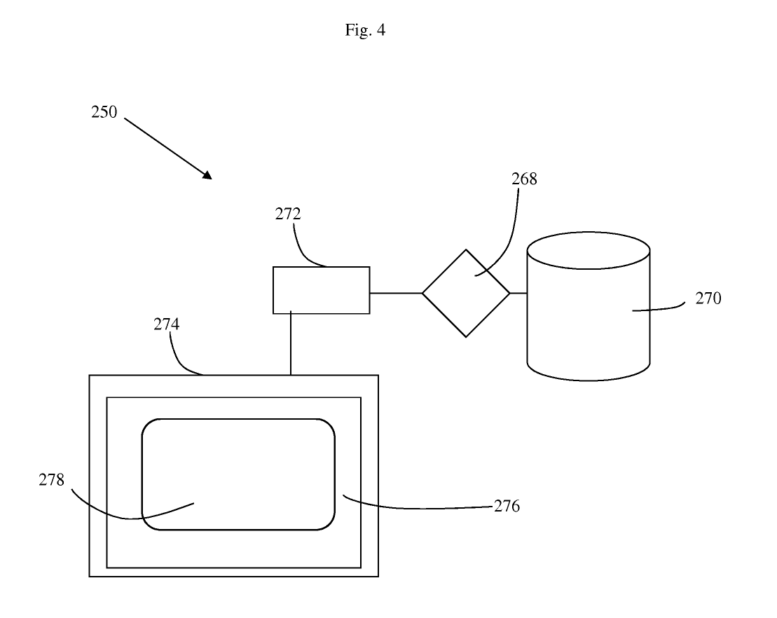

FIG. 4 illustrates an exemplary system 250 constructed in accordance with some embodiments of the invention. System 250 includes processing device 268 in communication with a database or memory device 270, communication or data input/output or communication device 272 and a display device 274. In some embodiments, display device 274 is a touch-enabled device and includes a data input device component. Memory device 270 may include data relating to the underlying game and embodiments of the invention as described herein, such as the preset criteria. A player interface 276 is displayed on display device 274 along with virtual representation of a layout, or a portion thereof, along with a player selection and wagering area 278 for transmitting selections and wagers in accordance with any of the embodiments herein, such as method 10 and 110. Game play is displayed on display device 274 and processing device 268 facilitates distribution of randomly generated hands of virtual cards from a modified deck to form the initial player hand for each player and the dealer hand, as well as additional cards from the modified deck responsive to receipt of the raise wager. Processing device 268 also determines the first and second wager outcomes by comparing the player first and second cards with the dealer first and second cards according to preset criteria and ranking hierarchy. The determined outcome may be indicated on display device 274.

The system and method are not limited to the specific embodiments described herein, but rather, components of the system and/or steps of the method may be utilized independently and separately from other components and/or steps described herein. For example, the system may also be used in combination with other wagering systems and methods, and is not limited to practice with only the system as described herein. Rather, any of the exemplary embodiments can be implemented and utilized in connection with many other wagering applications.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

Those skilled in the art will readily appreciate that the systems and methods described herein may be a standalone system or incorporated in an existing gaming system. The system of the invention may include various computer and network related software and hardware, such as programs, operating systems, memory storage devices, data input/output devices, data processors, servers with links to data communication systems, wireless or otherwise, and data transceiving terminals. It should also be understood that any method steps discussed herein, such as for example, steps involving the receiving or displaying of data, may further include or involve the transmission, receipt and processing of data through conventional hardware and/or software technology to effectuate the steps as described herein. Those skilled in the art will further appreciate that the precise types of software and hardware used are not vital to the full implementation of the methods of the invention so long as players and operators thereof are provided with useful access thereto, which may be through a mobile device, gaming platform, or other computing platform via a local network, global telecommunication network or the Internet.

Although specific features of various embodiments of the invention may be shown in some drawings and not in others, this is for convenience only. In accordance with the principles of the invention, any feature of a drawing may be referenced and/or claimed in combination with any feature of any other drawing.

While exemplary systems and methods, and applications of methods of the invention, have been described herein, it should also be understood that the foregoing is only illustrative of a few particular embodiments with exemplary and/or preferred features, as well as principles of the invention, and that various modifications can be made by those skilled in the art without departing from the scope and spirit of the invention. Therefore, the described embodiments should not be considered as limiting of the scope of the invention in any way. Accordingly, the invention embraces alternatives, modifications and variations which fall within the spirit and scope of the invention as set forth in the claims and equivalents thereto.

What is claimed is:

1. A method of conducting a wagering game, comprising the steps of:
a) receiving a first card wager and a second card wager from a participating player;
b) providing a randomly-ordered modified deck of physical playing cards, wherein the modified deck includes fifty-two standard playing cards, a first unique card including a uniquely identifiable characteristic which differentiates the first unique card from the fifty-two standard playing cards and a second unique card including a second uniquely identifiable characteristic which differentiates the first unique card from the fifty-two standard playing cards, the first and second uniquely characteristics differentiating the first and second unique cards from one another;
c) dealing cards from the randomly-ordered modified deck to form a player hand for the participating player and a dealer hand, wherein the player hand and the dealer hand are each dealt at least two cards;
d) dealing one or more cards from the randomly-ordered modified deck to add to the player hand responsive to receiving a raise wager from the participating player;
e) displaying the identity of one of the at least two cards forming the dealer hand;
f) determining the outcome of the first card wager based on a comparison of the one of the at least two displayed dealer cards and a player selected card from the player hand according to preset criteria and ranking hierarchy of the cards in the modified deck, wherein the outcome is one of a player win, a player loss or a push;
g) displaying the identity of another one of the at least two cards forming the dealer hand;
h) determining the outcome of the second card wager based on a comparison of the displayed another one of the at least two dealer cards and another player selected card from the player hand according to preset criteria and ranking hierarchy of the cards in the modified deck, wherein the outcome is one of a player win, a player loss or a push;
i) determining the outcome of the raise wager, wherein the outcome of the raise wager is a loss if any the outcomes of at least the first and second card wagers is not a player win; and
j) settling each wager by either returning the wager, collecting the wager or awarding a payout.

2. A method as recited in claim 1, wherein the player selected card is the same suit as the one of the at least two displayed dealer cards.

3. A method as recited in claim 1, wherein the outcome of the raise wager is a push if the outcomes of the first and second card wagers are both a player win.

4. A method as recited in claim 1, wherein the outcome of the raise wager is a player win if the outcomes of the first and second card wagers are both a player win.

5. A computer-aided method of providing a wagering game, including a data communication device, a processing device and a display device, comprising the steps of:
a) receiving a first card wager and a second card wager from a participating player through the data communication device;
b) the processing device facilitating the step of dealing cards from a randomly-ordered modified deck to form a player hand for the participating player and a dealer hand, wherein the player hand and the dealer hand are each dealt at least two cards, and wherein the modified deck includes fifty-two standard playing cards, a first unique card including a uniquely identifiable characteristic which differentiates the first unique card from the fifty-two standard playing cards and a second unique card including a second uniquely identifiable characteristic which differentiates the first unique card from the fifty-two standard playing cards, the first and second uniquely characteristics differentiating the first and second unique cards from one another;
c) the processing device facilitating the step of dealing one or more cards from the randomly-ordered modified deck to add to the player hand responsive to receiving a raise wager from the participating player through the data communication device;
e) displaying the identity of one of the at least two cards forming the dealer hand;
f) the processing device facilitating the step of determining the outcome of the first card wager based on a comparison of the one of the at least two displayed dealer cards and a player selected card from the player hand according to preset criteria and ranking hierarchy of the cards in the modified deck, wherein the outcome is one of a player win, a player loss or a push;
g) displaying the identity of another one of the at least two cards forming the dealer hand;
h) the processing device facilitating the step of determining the outcome of the second card wager based on a comparison of the displayed another one of the at least two dealer cards and another player selected card from the player hand according to preset criteria and ranking hierarchy of the cards in the modified deck, wherein the outcome is one of a player win, a player loss or a push;
i) the processing device facilitating the step of determining the outcome of the raise wager, wherein the outcome of the raise wager is a loss if any the outcomes of at least the first and second card wagers is not a player win; and
j) settling each wager by either returning the wager, collecting the wager or awarding a payout through the data communication device.

6. A computer-aided method as recited in claim 5, wherein the communication device, processing device and display device are mounted within a unitary housing.

7. A computer-aided method as recited in claim 5, wherein the processing device is remotely located from the display device and communication device.

8. A computer-aided method as recited in claim 5, further comprising displaying a table layout including a plurality of player positions on the display device.

9. A computer-aided method as recited in claim 5, wherein the player selected card is the same suit as the one of the at least two displayed dealer cards.

10. A computer-aided method as recited in claim 5, wherein the outcome of the raise wager is a push if the outcomes of the first and second card wagers are both a player win.

11. A computer-aided method as recited in claim 5, wherein the outcome of the raise wager is a player win if the outcomes of the first and second card wagers are both a player win.

12. A system comprising:
a) data communication device configured to receive a first card wager and a second card wager from a participating player;
b) a processing device configured to facilitate the steps of:
i) dealing of cards from a randomly-ordered modified deck to form a player hand for the participating player and a dealer hand, wherein the player hand and the dealer hand are each dealt at least two cards, and wherein the modified deck includes fifty-two standard playing cards, a first unique card including a uniquely identifiable characteristic which differentiates the first unique card from the fifty-two standard playing cards and a second unique card including a second uniquely identifiable characteristic which differentiates the first unique card from the fifty-two standard playing cards, the first and second uniquely characteristics differentiating the first and second unique cards from one another;
ii) dealing one or more cards from the randomly-ordered modified deck to add to the player hand responsive to receiving a raise wager from the participating player through the communication device;
iii) determining the outcome of the first card wager based on a comparison of the one of the at least two displayed dealer cards and a player selected card from the player hand according to preset criteria and ranking hierarchy of the cards in the modified deck, wherein the outcome is one of a player win, a player loss or a push;
iv) determining the outcome of the second card wager based on a comparison of the displayed another one of the at least two dealer cards and another player selected card from the player hand according to preset criteria and ranking hierarchy of the cards in the modified deck, wherein the outcome is one of a player win, a player loss or a push;
v) determining the outcome of the raise wager, wherein the outcome of the raise wager is a loss if any the outcomes of at least the first and second card wagers is not a player win;
vi) settling each wager by either returning the wager, collecting the wager or awarding a payout through the data communication device; and
c) a display device configured to display the identity of one of the at least two cards forming the dealer hand prior to receiving the selection of a player card and display the identity of another one of the at least two cards forming the dealer hand responsive to determining the outcome of the first card wager.

13. A system as recited in claim 12, wherein the data communication device, processing device and display device are mounted within a unitary housing.

14. A system as recited in claim 12, wherein the processing device is remotely located from the display device and data communication device.

15. A system as recited in claim 12, further comprising a plurality of player positions having display devices.
